(19) United States
(12) Patent Application Publication
(10) Pub. No.: US 2025/0223451 A1
(43) Pub. Date: Jul. 10, 2025

(54) COATING COMPOSITIONS OF ISOCYANATES AND BASIC METAL COMPOUNDS

(71) Applicant: SIKA TECHNOLOGY AG, Baar (CH)

(72) Inventors: Simone KLAPDOHR, Trostberg (DE); Norbert STEIDL, Trostberg (DE); Burkhard WALTHER, Trostberg (DE); Christian BRUCHERTSEIFER, Tecklenburg (DE); Olaf JANSSEN, Düsseldorf (DE)

(73) Assignee: SIKA TECHNOLOGY AG, Baar (CH)

(21) Appl. No.: 18/853,641

(22) PCT Filed: Apr. 12, 2023
(86) PCT No.: PCT/EP2023/059493

§ 371 Date: Oct. 2, 2024

(30) Foreign Application Priority Data
Apr. 13, 2022 (EP) 22168263.6

(51) Int. Cl. C09D 7/63; C08G 18/10; C08G 18/48; C08G 18/73; C08G 18/76; C08K 5/00; C08K 5/5419; C09D 5/18; C09D 7/61; C09D 7/65; C09D 175/08

(52) U.S. Cl. CPC C09D 7/63; C08G 18/10; C08G 18/4825; C08G 18/4829; C08G 18/73; C08G 18/7671; C09D 5/18; C09D 7/61; C09D 7/65; C09D 175/08; C08K 5/0091; C08K 5/5419

(57) ABSTRACT

A composition includes at least one polyisocyanate, particles of at least one basic metal compound, and at least one first additive which is a chelating agent including at least two functional groups capable of binding to a cation of the metal. Furthermore, a kit including the composition and a second composition containing water, the use of the composition for creating a coating and a process related thereto.

The present invention relates to a composition comprising at least one polyisocyanate, particles of at least one basic metal compound, and at least one first additive which is a chelating agent comprising at least two functional groups capable of binding to a cation of said metal. Furthermore, a kit comprising said composition and a second composition containing water, the use of the composition for creating a coating and a process related thereto are provided.

### BACKGROUND OF THE INVENTION

Coatings are an important and rapidly growing application providing added value. A coating often has a decorative and a protective function. Coating compositions for construction purposes, in particular for applications in flooring and waterproofing, are mostly based on epoxy resins or polyurethane resins (polyurethane polymers).

Epoxy resin based coating compositions provide aesthetically pleasing and glossy surfaces, but suffer from certain disadvantages, such as undesired blushing effects, especially at lower temperatures, temperature dependence of the gloss intensity, which may decrease in cold environments, and hazardous chemicals (i.e. epoxides and amines) involved.

Polyurethanes (PUs) consist of polymers composed of a chain of organic (monomer) units joined by carbamate (urethane) links resulting from the reaction between a hydroxyl group and an isocyanate group. The polymer chains may be branched depending on the monomers used and/or further (side) reactions such as the allophanate reaction and biuret reaction. Industrially, a polyurethane polymer is usually formed by reacting an isocyanate with a polyol. Both the isocyanate and the polyol each contain, on average, two or more functional groups per molecule. PUs can be produced in many different forms from very low-density foams to high performance composites and can thus be used in a multitude of applications. Examples of applications include flexible high-resilience seating foams, rigid foam insulation panels, electrical potting compounds, high performance adhesives, surface coatings, packaging materials, surface sealants and synthetic fibres. PU coatings are valued particularly for their durability, abrasion resistance, aesthetics, and flexibility in formulation. In addition, like PU adhesives, PU coatings can be delivered in numerous formats to meet the process requirements of almost every operation. For producing polyurethane-type polymers in principle two different systems can be distinguished.

For construction purposes, particularly for applications in flooring and waterproofing, the polyurethane based coating compositions often additionally contain polyureas formed from the isocyanates with amines. The amine can be formed either in situ by reaction of water with isocyanate and/or an accordingly blocked amine (latent hardener). The polyureas increase bonding to the surface coated, such as in particular cement and concrete surfaces. Polyureas consist of polymers composed of a chain of organic (monomer) units joined by urea links resulting from the reaction between an amine group and an isocyanate group. In the so-called one-component system (1K system), an isocyanate prepolymer (urethane prepolymer) or its solution is crosslinked and cured with moisture present in the ambient air.

An isocyanate prepolymer or polyurethane prepolymer is one in which all of the polyol hydroxyl end groups have been reacted with isocyanate groups leaving isocyanate functionality at the termini instead of hydroxyl groups.

In some formulations so-called latent hardeners are used, i.e. a hydrolysis-sensitive component that liberates a polyol and/or an amine upon reaction with water. Common examples for latent hardeners are imines or oxazolidines; however, they liberate a leaving group that evaporates and releases volatile organic compounds (VOCs) and intensive odours (for instance amines often have an unpleasant smell) or remains in the system and acts as a plasticizer.

In the so-called two-component system (2K system), an isocyanate component is reacted and cured with an amine and/or a polyol component. However, polymeric coatings obtained according to the above methods tend to foam or to trap gas bubbles during the polymerization process, particularly when applied in a thicker layer, e.g. to a thickness of more than 1 mm. The cause of foaming is carbon dioxide which inevitably forms during the reaction of isocyanate with water. Water is added as a curing agent, or is often contained in the starting material, i.e. the polyol component, and in materials to be added to the starting material, e.g. pigments and fillers.

When the urethane-type polymers are to be used for coatings, adhesives or sealants, the polymers are required to be non-foaming, i.e. not to be in the form of a foam after their curing process has ended. Such non-foaming urethane-type polymers can be prepared by adding basic materials to the isocyanate reactive mixture. The basic materials capture the carbon dioxide, acting as carbon dioxide scavengers.

Two-component polyurethane coating systems, sometimes called two-package coatings or 2K polyurethane systems, are probably the most commonly known of all the polyurethane coating systems. “Two-component” describes a process or system in which two resin packages (often referred to as part A and part B) are mixed immediately prior to the application of the coating. One package (often called “part A”) contains a resin having functional groups (e.g. hydroxy or amino groups) which are reactive towards isocyanate groups; the other package (often called “part B”) contains an isocyanate which is capable of reacting with said functional groups in part A. Key advantages of the two-component coating system are the much longer storage stability or shelf life of the isocyanate containing component (part B) compared to an isocyanate alone or the isocyanate prepolymer of the 1K system, a rapid curing reaction once the two resins have been mixed and a simple mixing process before application (WO 2019/137859 proposes such a 2K system).

Two-component polyurethanes using sufficiently slow curing amines and three-component polyurethanes using water and a CO₂-scavenger have been known for a long time. However, three-component packages are error prone in practical use and hence not popular in the market: The need to add a further component e.g. to the two-component system adds further packaging costs and complexity to the coating process. A high degree of component metering accuracy is required because polyurethane resins require precisely balanced mixing ratios and thorough mixing for good results. The amines used in the two-component polyurea compositions are relatively expensive and often unpleasantly smelly and hazardous.

Thus, a one-component system (1K system) using a prepolymer of an isocyanate and a polyol and having an improved shelf live is still desirable for its simplicity, while a two-component system (2K system) free of added amines is also desirable. The latter requires the in situ generation of amines from isocyanate and water, which generates CO₂ that to some extent can escape from the coating composition, but to a certain amount remains trapped therein as a gas, forming gas bubbles or pockets which cause unwanted foaming of the coating.

The use of metal oxides and hydroxides has been proposed to chemically capture such trapped CO₂ and preventing any gas bubbles or pockets from forming in order to suppress foaming (DE 1271978, EP 0161479 and WO 2019/137859).

Still, dispersions of e.g. calcium oxide or calcium hydroxide in water and polyol are difficult to stabilize in order to obtain storage-stable compositions with a sufficient shelf live, and it limits the range of suitable polyols, fillers, and pigments due to the highly alkaline environment in the composition or dispersion.

In order to avoid such unstable dispersions with a relatively short shelf life it appears desirable to pre-disperse the carbon dioxide scavenger not in the polyol component, as in WO 2019/137859, but instead in the isocyanate component, thereby also eliminating the need for incorporating the carbon dioxide scavenger during mixing of the components or immediately before the application of the reactive system. However, the main problem for realizing a storage stable dispersion of basic (“basic” meaning chemically reacting as a base, e.g. causing an alkaline pH in contact with water) metal oxide and hydroxide particles, such as calcium oxide in isocyanate compounds, is posed by basic substances catalyzing the trimerization of isocyanates which in turn leads to a significant increase in viscosity in a relatively short period of time. Also, the alkaline pH of such dispersions is detrimental to many further ingredients, such as e.g. pigments in dispersions for those applications for which colour matters; the alkaline environment often causes a change and/or fading of the colours.

Therefore, an object of the present invention is to provide storage-stable compositions, particularly dispersions, of a carbon dioxide scavenger and an isocyanate compound. The viscosity of said composition, particularly the viscosity of the isocyanate compound therein should not rise significantly upon storage under normal conditions such as room temperature. Moreover, the functionality of other ingredients should not be impaired over time and during storage.

### BRIEF DESCRIPTION OF THE INVENTION

It has surprisingly been found that shielding of the external surfaces of basic metal oxide and hydroxide particles with certain additives can prevent the problem of uncontrolled viscosity increase and unwanted effects on other ingredients, without impairing their carbon dioxide scavenging efficacy. To the contrary, those metal oxide and hydroxide particles modified with certain additives are sufficiently reactive or surprisingly even more reactive than the unmodified particles in capturing the CO₂ by formation of metal carbonate. Less amount of the inorganic particles is necessary than with unmodified particles in the formulation of bubble-free coatings. Particularly, an additive which is a chelating agent comprising at least two functional groups capable of binding to a cation of the metal of the basic metal oxide or hydroxide provides sufficient shielding. This stabilizes the isocyanate or the isocyanate prepolymer in the composition, other ingredients and thus the composition as a whole.

The invention thus provides
(1) a composition comprising
   (a) at least one polyisocyanate,
   (b) particles of at least one basic metal compound independently selected from the group consisting of basic metal oxide compounds and basic metal hydroxide compounds, and
   (c) at least one first additive which is a chelating agent comprising at least two functional groups capable of binding to a cation of said metal;
(2) a composition according to item (1), wherein the at least one polyisocyanate is a prepolymer formed of at least one polyol and at least one polyisocyanate;
(3) a kit comprising the composition as defined hereinbefore at item (1) and a second composition which is a liquid comprising water for reaction with the at least one polyisocyanate and/or prepolymer and optionally for reaction with the at least one basic metal compound;
(4) a use of the composition as defined hereinbefore at item (1) for creating a coating by reaction with ambient moisture;
(5) a use of the composition as defined hereinbefore at item (1) for creating a coating after mixing said composition with a second composition which is as defined hereinbefore at item (3);
(6) a process for creating a coating on a surface, comprising the steps of
   (i) providing a composition as defined hereinbefore at item (1),
   (ii) allowing the presence of ambient moisture,
   (iii) applying the composition onto the surface, and
   (iv) allowing the composition as applied in step (iii) to cure while it is in contact with the ambient moisture;
(7) a process for creating a coating on a surface, comprising the steps of
   (i) providing a first composition as defined hereinbefore at item (1),
   (ii) providing a second composition which is as defined hereinbefore at item (3),
   (iii) mixing the first and second composition,
   (iv) applying the mixture obtained in step (iii) onto the surface, and
   (v) allowing the mixture as applied in step (iv) to cure.

### DETAILED DESCRIPTION OF THE INVENTION

Compound names beginning with “poly” designate substances, which formally contain per molecule two or more of the respective functional group or monomer or repeating unit referred to. In case of functional groups, the compound itself can be a monomeric, oligomeric or polymeric compound. For instance, a polyol is a compound having two or more hydroxy groups, a polyisocyanate is a compound having two or more isocyanate groups. A polyurethane is a polymeric compound resulting from the polyaddition between a polyisocyanate and a polyol. Polybutadiene is a polymer resulting from the polymerization of 1,3-butadiene.

The term “average functionality” denotes the average number of functional groups on a given molecule.

“M_{w}” represents the weight average molecular weight and is determined according to DIN 55672-1 and referred to polystyrene calibration standard. “% by weight” as used in the present invention is with respect to the total weight of the composition if not indicated otherwise. “wt. %”, “wt. %” or “wt %” as used herein means weight percent (%) or percent (%) by weight, in each case with respect to the total weight of the composition if not indicated otherwise.

The expressions “C₁₄ to C₂₂”, “C₁₆ to C₁₈”, “C₁₆ to C₁₈”, “C₁₈” and the like, such as in “C₁₄ to C₂₂ fatty acid esters”, “C₁₆ to C₁₈ fatty acid esters”, “C₁₆ to C₁₈ fatty acid esters”, “C₁₈ fatty acid esters”, “C₁₄ to C₂₂ fatty alcohols”, “C₁₆ to C₁₈ fatty alcohols”, “C₁₆ to C₁₈ fatty alcohols” and “C₁₈ fatty alcohols” and the like refer to the length of the main hydrocarbon chain or hydrocarbon backbone of the fatty acid and fatty alcohol, respectively, and functional groups, such as e.g. ethers or esters, if attached thereto, do not count towards the length of the hydrocarbon backbone.

The expressions “C₁ to C₆” alkyl, “C₁ to C₁₀” alkyl and “C₁ to C₁₀₀” alkyl and the like refer to alkyl residues having from 1 to 6, from 1 to 10 and from 1 to 100 carbon atoms, respectively, and the like.

Likewise, the terms “C₄- to C₁₀₀-hydrocarbon tail”, “C₄- to C₂₂-hydrocarbon tail” and “C₆- to C₁₈-hydrocarbon tail” denote a hydrocarbon tail having from 4 to 100, from 4 to 22 and from 6 to 18 carbon atoms, respectively.

The term “alkyl” implies a fully saturated hydrocarbon chain with no C—C-double or triple bonds, whereas the terms “hydrocarbon backbone” or “hydrocarbon tail” embrace saturated, unsaturated and polyunsaturated hydrocarbon chains, such as alkyl, alkene and alkyne residues, unless otherwise indicated, e.g. by expressions such as “saturated”, “unsaturated” or “polyunsaturated”.

The term “repeating unit” or “repeat unit” refers to an elementary structural unit which periodically repeats itself along the polymeric chain and is also defined as a monomer or monomeric unit. The repeating unit or monomer is thus a low molecular weight compound from which the polymer is obtained through synthetic chemical reaction(s). For instance, a poly-1,2-propyleneether diol can be represented by the formula H—[OCH₂CH(CH₃)-]ₙOH with n being an integer of usually 4 or greater and the isopropoxy (isopropyleneoxide) (isopropylene oxide) residue [OCH₂CH(CH₃)-] as the repeating unit.

The term “oligomer” denotes a molecule that consists of 2-10 monomers without having necessarily a molecular mass distribution.

The term “prepolymer” refers to a monomer or system of monomers that have been reacted to an intermediate molecular mass state. This material is capable of further polymerization by reactive groups to a fully cured high molecular weight state. An isocyanate prepolymer or polyurethane prepolymer is one in which all of the polyol hydroxyl end groups have been reacted with isocyanate groups leaving isocyanate functionality at the termini instead of hydroxyl groups.

It is to be understood that this invention is not limited to the particular compositions and formulations described, since such compositions and formulations may, of course, vary. It is also to be understood that the terminology used herein is not intended to be limiting, since the scope of the present invention will be limited only by the appended claims.

“Independently selected” from a list or group of items means that the items selected may be the same or may be different from each other, particularly in case “at least one” item being selected, which includes the options of one or more items, such as two, three, four or more items being selected, which should thus be selected independently from each other, i.e. the items can all be the same or different.

If hereinafter a group is defined to comprise at least a certain number of embodiments, this is meant to also encompass a group which preferably consists of these embodiments only. Furthermore, the terms “first”, “second”, “third” etc., (i), (ii), (iii) etc., “(a)”, “(b)”, “(c)”, “(d)” etc. and the like, as or if used in the description and in the claims, are used for distinguishing between similar or different elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third”, or “(A)”, “(B)” and “(C)”, or “(a)”, “(b)”, “(c)”, “(d)”, or “I”, “ii”, “iii” etc. relate to steps of a method or use or assay, there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary or against the gist of the invention. In particular, any feature indicated as being preferred or advantageous may be combined with any other feature or features, be it preferred or advantageous or not.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

### Polyisocyanates

The term “polyisocyanate” or “polyisocyanate compound”, as used interchangeably herein, denotes an isocyanate compound which has at least two isocyanate groups, particularly at least two free isocyanate groups. A “free isocyanate group” is a functional isocyanate group that is not blocked or protected and thus is capable of undergoing a chemical reaction, for instance a reaction with water or the hydroxy group of an alcohol, particularly with one of the hydroxy groups of a polyol.

Particularly, the polyisocyanate of the invention can have from 2 to 6 (free) isocyanate groups, preferably 2 or 3 (free) isocyanate groups. The isocyanate may be selected from the group consisting of aliphatic and aromatic isocyanate compounds.

Polyisocyanate includes aliphatic polyisocyanate, cycloaliphatic polyisocyanate, aromatic polyisocyanate, modified polyisocyanate containing for example uretonimine groups, allophanate groups, isocyanurate groups, urethane groups or biuret groups.

In one aspect, the polyisocyanate is a diisocyanate of the abovementioned aliphatic polyisocyanate, cycloaliphatic polyisocyanate, aromatic polyisocyanate and modified polyisocyanate.

Suitable cycloaliphatic polyisocyanates include those in which two or more of the isocyanato groups are attached directly and/or indirectly to the cycloaliphatic ring. Aromatic polyisocyanates include those in which two or more of the isocyanato groups are attached directly and/or indirectly to the aromatic ring.

The aliphatic polyisocyanates and cycloaliphatic polyisocyanates can comprise from 4 to 100 carbon atoms linked in a straight chain or cyclized.

Suitable polyisocyanates are selected from the group consisting of pentamethylene diisocyanate, hexamethylene diisocyanate (HDI), Isophorone diisocyanate (IPDI), 2,2,4- and 2,4,4-trimethyl-1,6-hexamethylene diisocyanate, tetramethoxybutane 1,4-diisocyanate, butane-1,4-diisocyanate, dicyclohexylmethane diisocyanate, cyclohexane 1,3- and 1,4-diisocyanate, 1,12-dodecamethylene diisocyanate, diisocyanates of dimeric fatty acids; lysine methyl ester diisocyanate, 1-isocyanato-3,3,5-trimethyl-5-isocyanatomethylcyclohexane, hydrogenated diphenylmethane diisocyanate (H12MDI), hydrogenated 2,4-tolylene diisocyanate, hydrogenated 2,6-tolylene diisocyanate, methylene diphenyl diisocyanate (MDI), 2,4-toluene diisocyanate (2,4-TDI), 2,6-toluene diisocyanate (2,6-TDI), naphthalene diisocyanate (NDI), tetramethylxylylene diisocyanate (TMXDI), p-xylylene diisocyanate, and mixtures of these compounds, polymeric methylene diphenyl diisocyanate, carbodiimide-modified methylene diphenyl diisocyanate, tris-(isocyanatohexyl)-isocyanurate and mixtures with the higher homologues thereof, tris-(isocyanatohexyl)-biuret or mixtures with the higher homologues. Methylene diphenyl diisocyanate (MDI) is available in three different isomeric forms, namely 2,2′-methylene diphenyl diisocyanate (2,2′-MDI), 2,4′-methylene diphenyl diisocyanate (2,4′-MDI) and 4,4′-methylene diphenyl diisocyanate (4,4′-MDI). MDI can be classified into monomeric MDI (also designated MMDI) and polymeric MDI (PMDI) referred to as technical MDI. For the present invention, polymeric MDI is the preferred one. Polymeric MDI includes oligomeric species and MDI isomers. Thus, polymeric MDI may contain a single MDI isomer or isomer mixtures of two or three MDI isomers, the balance being oligomeric species. Polymeric MDI tends to have isocyanate functionalities of higher than 2. The isomeric ratio as well as the amount of oligomeric species can vary in wide ranges in these products. For instance, polymeric MDI may typically contain about 20 to 80 wt. % of monomeric MDI isomers, the balance being said oligomeric species. The MDI isomers are often a mixture of 4,4′-MDI, 2,4′-MDI and low levels of 2,2′-MDI.

Preferably, the polyisocyanate is selected from the group consisting of oligomers and/or prepolymers of hexamethylene diisocyanate (HDI), methylene diphenyl diisocyanate (MDI) or a derivative of MDI, such as polymeric methylene diphenyl diisocyanate, carbodiimide-modified methylene diphenyl diisocyanate.

More preferably, the polyisocyanate is selected from the group consisting of hexamethylene diisocyanate (HDI), methylene diphenyl diisocyanate (MDI), isophorone diisocyanate (IPDI) and toluene diisocyanate (TDI), yet more preferably selected from the group consisting of IPDI, TDI and methylene diphenyl diisocyanate (MDI). The polyisocyanate may also be selected from oligomers and/or prepolymers of the aforementioned polyisocyanates.

Polymeric methylene diphenyl diisocyanate and carbodiimide-modified methylene diphenyl diisocyanate are commercially available, for e.g. Lupranat® M, Lupranat® MI and Lupranat® MM from BASF SE or Desmodur MDI-types from Covestro and polyisocyanate resin based on hexamethylene diisocyanate (HDI) is commercially available, for e.g. Desmodur N Types® from Covestro, Tolonate™ X Flo from Vencorex.

The polyisocyanate can be in any physical state. Preferably the polyisocyanate is in a liquid state.

Preferably, the at least one polyisocyanate is present in an amount in the range of ≥10 wt. % to ≤90 wt. %, more preferably in the range of ≥20 wt. % to ≤ 90 wt. %, more preferably in the range of ≥20 wt. % to ≤80 wt. %, most preferably in the range of ≥30 wt. % to ≤80 wt. %, based on the total weight of the composition.

The polyisocyanate may be a prepolymer formed of a polyol and a polyisocyanate. In this aspect the polyisocyanate reacted with the polyol preferably has at least two free isocyanate groups. This advantageously results in the presence of at least two (free) isocyanate groups in the prepolymer.

The polyisocyanate of the invention preferably does not contain any ionic groups.

### Basic Metal Compound

“Basic” in this context means capable of chemically reacting as a base, e.g. causing an alkaline pH in contact with water. Thus, any basic metal compound in that sense and selected from the group consisting of basic metal oxide compounds, more briefly referred to a basic metal oxides, and basic metal hydroxide compounds, more briefly referred to a basic metal hydroxides, is suitable. Thus, the basic metal compound may particularly be selected from the group consisting of basic metal oxide compounds, from the group consisting of basic metal hydroxide compounds or from the group consisting of a combination of both of said groups. In one aspect the basic metal compound may be a combination of one or two basic metal oxides with one or two basic metal hydroxides. In a further aspect the basic metal compound may be a combination of exactly two basic metal oxides with exactly two basic metal hydroxides. In a further aspect the basic metal compound may be a combination of exactly one basic metal oxide with exactly one basic metal hydroxide. Preferably the metal or metals of the said combinations of oxide(s) and hydroxide(s) are the same, for instance calcium oxide (CaO) and magnesium oxide (MgO) are combined with calcium hydroxide (Ca(OH)₂) and magnesium hydroxide (Mg(OH)₂), or MgO is combined with Mg(OH)₂, or CaO is combined with Ca(OH)₂, and the like. The selection of the basic metal compound may be such that it results in two or more basic metal compounds being selected, e.g. two oxides, or two hydroxides, or one oxide with one hydroxide, or two oxides with one hydroxide. The presence of at least one basic metal oxide in the selection made and in the composition of the invention is preferred.

Compounds, i.e. oxides and/or hydroxides of those metals which at standard conditions predominantly occur in one of the oxidation states of +I, +II and +III are preferred, with +II being more preferred.

The basic metal compound can advantageously be selected from the oxides and hydroxides of the metal elements of group 1 (IA; alkaline metals), group 2 (IIA; alkaline earth metals), group 3 (IIIB; 3^{rd} transition metal group) and group 12 (IIB; 2^{nd} transition metal group) in the periodic table of the elements, preferably is selected from the oxides and hydroxides of the alkaline metals, alkaline earth metals, scandium and zinc, more preferably is selected from the oxides and hydroxides of the alkaline metals and alkaline earth metals, yet more preferably is selected from the oxides and hydroxides of the alkaline earth metals.

The basic metal compound may also be selected from the oxides and hydroxides of the group consisting of beryllium, magnesium, calcium, barium, zinc and scandium, preferably selected from the oxides and hydroxides of the group consisting of magnesium, calcium and zinc, more preferably magnesium, and calcium, most preferably calcium.

The basic metal compound may also be selected from the group consisting of calcium oxide, magnesium oxide, calcium hydroxide and magnesium hydroxide, preferably calcium oxide and calcium hydroxide, most preferably calcium oxide. It is understood that in one aspect, depending on the source material for the basic metal compound(s), such as e.g. cement, the basic metal oxides and hydroxides of the invention may in practice and with respect to purity be of technical grade and/or contain a certain residual amount of water, although higher grades of purity such as a purity of at least 97%, at least 98% or at least 99% would also work. Likewise, magnesium oxide and/or magnesium hydroxide, particularly magnesium oxide, may be present in the compositions of the invention in-compared to calcium oxide and/or calcium hydroxide-relatively small amounts only, such as of up to 5 wt. %, preferably of up to 3 wt. %, more preferably of up to 2 wt. %, yet more preferably of up to 1 wt. %, most preferably of up to 0.5 wt. %, based on the total weight of the composition. In this context, alkaline metal oxides, such as e.g. sodium oxide (Na₂O) and/or potassium oxide (K₂O), may be present in even smaller amounts such as of up to 0.5 wt. %, preferably of up to 0.2 wt. %, more preferably of up to 0.1 wt. %, yet more preferably of up to 0.05 wt. %, most preferably of up to 0.01 wt. %, based on the total weight of the composition.

Thus, in one aspect the basic metal compound can comprise cement, preferably tricalcium silicate (white cement) or calcium aluminate cement, more preferably calcium aluminate cement. Particularly in case the basic metal compound is selected from the group consisting of calcium oxide, magnesium oxide, calcium hydroxide and magnesium hydroxide, preferably calcium oxide and calcium hydroxide, most preferably calcium oxide, the basic metal compound may be sourced from cement, preferably tricalcium silicate (white cement) or calcium aluminate cement, more preferably calcium aluminate cement. Thus, in one aspect the basic metal compound may comprise cement, preferably tricalcium silicate (white cement) or calcium aluminate cement, more preferably calcium aluminate cement.

The presence of the basic metal compound prevents the formation of bubbles or blisters in the cured coating composition, particularly on its surface, by capturing or quenching the CO₂ which is generated by the reaction of the isocyanate compounds with water.

The dispersion of the particles of the basic metal compound, i.e. the basic metal oxide and/or hydroxide compound in the one- or two-component (coating) composition of the invention needs to be stabilized or else the particles tend to form a sediment, which is not re-dispersible, within a few days of time. The first additive according to the invention helps stabilizing the compositions as dispersions. The use of a plasticizer provides additional stabilization in this regard.

The particle size of the basic metal compound particles is preferably in the range of from 2 μm to 200 μm.

The amount of the basic metal compound particles in one of the compositions according to the invention can be in the range of from 1 wt. % to 75 wt. %, preferably of from 5 wt. % to 75 wt. %, more preferably of from 10 wt. % to 75 wt. %, most preferably of from 10 wt. % to 45 wt. %, based on the weight of the polyisocyanate compound. However, depending on the composition, the amount of the basic metal compound particles can also be in the range of from 1 wt. % to 40 wt. % or from 10 wt. % to 35 wt. %, based on the weight of the polyisocyanate compound (“wt. %”, “wt. %” or “wt %” means weight percent or percent by weight).

### First Additive (Chelating Agent)

The first additive in the compositions of the invention is a chelating agent, particularly an organic chelating agent, and is also called a chelating ligand. “Organic chelating agent” denotes a chelating agent which constitutes an organic compound or molecule. Organic compounds usually contain, with few exceptions such as urea, at least one carbon-hydrogen bond. Therefore, inorganic chelating agents such as Zn²⁺-ions are excluded and not within the meaning of the term “chelating agent” according to the present invention.

Chelating agents according to the invention are those which comprise at least two functional groups capable of binding to a cation of the metal (M) of the basic metal compound according to the invention, particularly cations carrying one (M⁺), two (M²⁺) or three positive (M³⁺) charges, preferably one or two positive charges, more preferably two positive charges.

To this end it is preferred that at least one of the at least two functional groups capable of binding to a cation of the metal (M) is an acid group-containing functional group, i.e. a functional group containing an acid group or one of its derivatives; said functional group may contain at least one acid group, but usually contains exactly one acid group. However, an acid anhydride may be considered to contain two acid groups as it is the anhydride of two free acids. Such acid group-containing functional groups according to the invention are the acids themselves, also called “free acids”, and their derivatives, i.e. their corresponding acid anions, salts, amides, anhydrides and esters, particularly the free carboxylic acid, free sulfonic acid, free phosphonic acid and free phosphoric acid, and their corresponding acid anions, salts, amides, anhydrides and esters. For instance, a carboxylic ester, a carboxylic anhydride and a carboxamide each is a carboxylic acid group-containing functional group, a sulfonate and a sulfonic acid sodium salt each is a sulfonic acid group-containing functional group, and a phosphonate ester is a phosphonic acid group-containing functional group.

The chelating agent can comprise one or more sterically hindering groups, preferably one sterically hindering group.

A sterically hindering group is a sterically more demanding organic group containing at least four carbon atoms.

Thus, in one aspect the sterically hindering groups of the invention are independently selected from the group consisting of a C₄- to C₁₀₀-hydrocarbon tail and a polyether, preferably a C₄- to C₂₂-hydrocarbon tail and a polyether, more preferably a C₆- to C₁₈-hydrocarbon tail and a polyether having from 3 to 50 repeating units.

The hydrocarbon tail can be a linear or branched hydrocarbon chain. The hydrocarbon chain can be saturated, (partially) unsaturated or polyunsaturated.

The chain between the functional groups binding to the metal cation is a C₂- to C₁₀-hydrocarbon backbone, preferably a C₂- to C₄-hydrocarbon backbone. One or more methylene groups of the aforementioned hydrocarbon backbone may be substituted by a heteroatom independently selected from the group consisting of N, P, O and S.

One or more methylene groups of the C₂- to C₁₀-hydrocarbon backbone or C₂- to C₄-hydrocarbon backbone may carry functional groups being independently selected from the group consisting of acid groups and their corresponding acid anions, salts, amides, anhydrides and esters, and amino and hydroxy, preferably consisting of acid groups selected from the group consisting of carboxylic acid, sulfonic acid, phosphonic acid and phosphoric acid and their corresponding acid anions, salts, amides, anhydrides and esters, and amino and hydroxy, or consisting of amino, carboxylate, carboxamide, carboxylic ester, carboxylic anhydride, hydroxy, sulfonate, phosphonate and phosphate. The hydrocarbon backbone can be a linear or branched hydrocarbon backbone. The hydrocarbon backbone can be saturated, (partially) unsaturated or polyunsaturated.

Chelating agents according to the invention preferably comprise at least two functional groups each of which carries at least one heteroatom selected from the group consisting of oxygen and nitrogen. The at least two functional groups may be the same or different. The presence of at least one acid group containing functional group is preferred.

The said acid group-containing functional group is preferably selected from the group consisting of acid groups and their corresponding acid anions, salts, amides, anhydrides and esters.

The acid group(s) may be selected from the group consisting of carboxylic acid, sulfonic acid, phosphonic acid and phosphoric acid.

Thus, the at least two functional groups may be selected from the group consisting of acid group containing functional groups being selected from the group consisting of carboxylic acid, sulfonic acid, phosphonic acid and phosphoric acid and their corresponding acid anions, salts, amides, anhydrides and esters, and amino and hydroxy.

Also, the acid group-containing functional group may be selected from the group consisting of carboxylic acid, sulfonic acid, phosphonic acid and phosphoric acid, their corresponding acid anions and acid salts, carboxamide, carboxylic esters and carboxylic anhydrides.

Thus, the at least two functional groups may be selected from the group consisting of acid group containing functional group being selected from the group consisting of carboxylic acid, sulfonic acid, phosphonic acid and phosphoric acid, their corresponding acid anions and acid salts, carboxamide, carboxylic esters and carboxylic anhydrides, and amino and hydroxy.

More particularly, amino may include primary, secondary and tertiary amino. Acid anions may be carboxylate, phosphonate, phosphate and sulfonate. It is understood that chelating agents containing one or more of a functional group selected from phosphonate, phosphate and sulfonate are also employed as their corresponding salts, e.g. salts with alkaline metals or ammonium.

In one aspect the chelating agent carries (in the same molecule) two or more functional groups of the same kind or of two or three kinds as listed before. Preferably one chelating agent carries two or more functional groups of the same kind or of two kinds as listed before. Suitable combinations in this regard are for instance: one or more hydroxy groups with one or more carboxylate groups or carboxyl groups, such as in hydroxy carboxylic acids, such as citric acid; one or more amino groups with one or more carboxyl groups, such as in amino acids; one or more amino, particularly tertiary amino groups with one or more carboxylate groups, such as in ethylenediamine tetraacetate (EDTA); one or more amino groups, particularly tertiary amino groups, with one or more phosphonate groups; two or more carboxyl groups, such as in di- and tricarboxylic acids.

In one aspect the chelating agent is selected from
a.1) amino acids, particularly naturally occurring amino acids, more preferably proteinogenic amino acids, such as e.g. lysine, aspartic acid, glutamic acid and serine
a.2) polyphosphonic acids, such as e.g. diphosphonic acids, such as e.g. [[(Hydroxyethyl)imino]bis(methylene)]bisphosphonic acid (HEMPA) and those of formula A

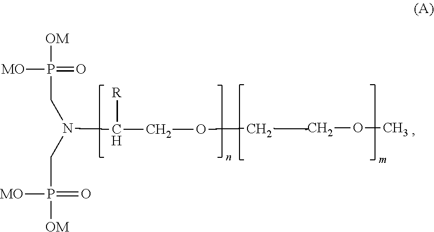

wherein R is H or CH₃, m+n is an integer from 3 to 60, preferably from 4 to 45, more preferably from 10 to 45, most preferably from 35 to 45, and M is selected from the group consisting of H, Na, K and NR₄ (R is selected from the group consisting of H, C₁ to C₄ alkyl, benzyl and oleyl; in case of all R being selected as H, R₄N⁺ is ammonium);
triphosphonic acids, such as e.g. 2-phosphonobutane-1,2,4-tricarboxylic acid (PBTC);
tetraphosphonic acids, such as e.g.
hexylene-1,6-diamine-tetrakis(methylphosphonic acid) (HDTMP) and ethylene-1,2-diamine-tetrakis(methylenephosphonic acid); and
pentaphosphonic acids, such as e.g. diethylenetriamine-pentakis(methylenephosphonic acid) (DTPMPA;
[[(phosphonomethyl)imino]bis[ethane-2,1-diylnitrilobis(methylene)]]tetrakisphosphonic acid) and bis(hexamethylene)triamine-pentakis(methylenephosphonic acid) (BHMTMP)
a.3) phosphoric acids and phosphonic acids, such as e.g. P-[(tetrahydro-2-hydroxy-2-oxido-4H-1,4,2-oxazaphosphorin-4-yl)methyl]phosphonic acid
a.4) sulfonic acids including monosulfonic acids, such as e.g. aminoalkylsulfonic acids, e.g. aminoethylsulfonic acid and aminopropylsulfonic acid, aminoethyl-aminopropanesulfonic acid and its sodium salt, cyclohexylaminopropanesulfonic acid and its sodium salt, and arylsulfonic acids, e.g. orthanilic acid (2-aminobenzenesulfonic acid), and disulfonic acids, such as e.g. dihydroxybenzenedisulfonic acids, e.g. 4,5-dihydroxybenzene-1,3-disulfonic acid and its salts, anilinedisulfonic acid, e.g. aniline-2,5-disulfonic acid and its salts, 4-amino-5-hydroxy-2,7-naphthalenedisulfonic acid, and polysulfonic acids, such as e.g. poly(2-acrylamido-2-methyl-1-propanesulfonic acid) (PolyAMPS), melamine sulfonate condensates (sulfonated melamine formaldehyde condensates) and lignosulfonate including lignosulfonate sodium salt
a.5) superplasticizers, particularly melamine derivatives, such as sulfonated melamine formaldehyde condensate
a.6) carboxylic esters, such as e.g. acetylacetonemethacrylate and 2-[2-[(2-methyl-1-oxo-2-propene-1-yl)oxy]ethyl]-3-oxobutanoic acid
a.7) carboxylic anhydrides, such as e.g. (2-dodecene-1-yl)-succinic anhydride, dihydro-3-(octadecenyl) furan-2,5-dione and dihydro-3-(hexadecenyl) furan-2,5-dione
a.8) polyhydroxy carboxylic acids, particularly monocarboxylic acids carrying from 2 to 6, preferably from 2 to 5, more preferably from 2 to 4 or from 3 to 5, most preferably 5 hydroxy groups, such as e.g. gluconic acid
a.9) carboxylic acids, such as e.g. acetoacetic acid, and
a.10) polycarboxylic acids, such as e.g. di-, tri-, tetra-, penta- and hexacarboxylic acids, particularly dicarboxylic acids, such as e.g. oxalic acid, malonic acid, succinic acid, glutaric acid, adipic acid and 2-[2-[(2-methyl-1-oxo-2-propene-1-yl)oxy]ethyl]-propanedioic acid, tetra-carboxylic acids, such as e.g. ethylenediaminetetraacetic acid (H4-EDTA), and polycarboxylic acids, such as e.g. polyacrylic acids (PAA), polymethacrylic acids (PMAA) and co-polymers of polyacrylic acid and methacrylic acid (collectively referred to as “poly(meth)acrylic acids” or “P(M)AA”), which optionally carry side chains selected from the group consisting of poly-C₁ to C₄-alkylene glycol, such as e.g. polyethylene glycol and polypropylene glycol, each terminated by a methoxy or ethoxy group,
   all of which may be (further) substituted by C to C₆ alkyl or C₁ to C₆ alkoxy, which may be linear or branched, and saturated or unsaturated.

In a further aspect, in combination with or separately to the previous aspect, the chelating agent is selected from
b.1) amino acids, particularly naturally occurring amino acids, more preferably proteinogenic amino acids
b.2) polyphosphonic acids including diphosphonic acids, triphosphonic acids, tetraphosphonic acids and pentaphosphonic acids
b.3) phosphoric acids and phosphonic acids
b.4) sulfonic acids including monosulfonic acids having at least one further functional group selected from the group consisting of amino and hydroxy, disulfonic acids and polysulfonic acids
b.5) superplasticizers
b.6) carboxylic esters
b.7) carboxylic anhydrides
b.8) polyhydroxy carboxylic acids
a.9) carboxylic acids, and
b. 10) polycarboxylic acids, such as e.g. dicarboxylic acids, tricarboxylic acids, tetracarboxylic acids and polycarboxylic acids,
   all of which may be (further) substituted by C₁ to C₆ alkyl or C₁ to C₆ alkoxy, which may be linear or branched, and saturated or unsaturated.

The chelating agents of the invention can be employed as free acids, part-neutralized acids or neutralized acids. In case of part-neutralized acids the chelating agents can be employed as hydrogen salts, in case of neutralized acids the chelating agents can be employed as salts. The counterions M⁺ in those salts and hydrogen salts may be selected from the group consisting of Na⁺, K⁺ and R₄N⁺ with R being selected from the group consisting of H, C₁ to C₄ alkyl, benzyl and oleyl; in case of all R being selected as H, R₄N⁺ is ammonium. The salts and hydrogen salts may be mixed salts containing at least two different kinds of counterion.

In a further aspect the chelating agent is additionally, in combination with or separately to the previous aspects selected from the group consisting of
c.1) bidentate chelating agents, such as e.g. acetylacetone (acac), ethylenediamine (en), oxalate (ox), tartrate (tart), dimethylglyoxime (dmg), 8-hydroxychinoline (oxin), 2,2′-bipyridine (bpy), 1,10-phenanthroline (phen), dimercaptosuccinic acid (DMSA) and 1,2-bis(diphenylphosphino)ethane
c.2) tridentate chelating agents, such as e.g. 2-(2-aminoethylamino) ethanol (AEEA), diethylenetriamine (dien), iminodiacetate (ida) and citrate (cit)
c.3) tetradentate chelating agents, such as e.g. triethylenetetramine (trien, TETA), triaminotriethylamin (tren), nitrilotriacetate (nta), bis(salicylidene)ethylenediamine (salen)
c.4) pentadentate chelating agents, such as e.g. ethylenediaminetriacetate (ted)
c.5) hexadentate chelating agents, such as e.g. ethylenediaminetetraacetate (EDTA)
c.6) octadentate chelating agents, such as e.g. diethylenetriaminepentaacetate (DTPA) and 1,4,7,10-tetraazacyclododecane-1,4,7,10-tetraacetate (DOTA), and
c.7) decadentate chelating agents, such as e.g. triethylenetetraminehexaacetate (TTHA).

The amount of first additive (chelating agent) usually is in the range of from 0.1 wt. % to 10 wt. %, preferably of from 0.3 wt. % to 6 wt. %, based on the weight of the basic metal compound particles. The first additive can also be pre-dissolved in water, for example by employing the first additive in admixture (emulsion) with or as a solution in water. In this aspect the amount of water used preferably is from 5 wt. % to 80 wt. %, more preferably from 5 wt. % to 75 wt. %, yet more preferably from 10 wt. % to 75 wt. %, yet more preferably from 35 wt. % to 60 wt. %, most preferably from 40 wt. % to 55 wt. %, based on the weight of the admixture or solution containing the first additive and water.

In one aspect of the invention, two or more first additives (chelating agents), preferably two first additives may be mixed. In a further aspect of the invention, a first additive may be mixed with another first additive, both of which are pure, i.e. not pre-dissolved in water. In yet a further aspect of the invention, a first additive which is pure, i.e. not pre-dissolved in water, may be mixed with another first additive which is pre-dissolved in water. In another aspect of the invention, two different first additives, both of which are pre-dissolved in water, may be mixed.

The chelating agent appears to shield the basic metal compound to an extent that its reactivity is moderated, suppressing its contribution to trimerization of the isocyanate and any other reactions thereof, which would otherwise lead to a significant increase in viscosity of the compositions of the present invention in a relatively short period of time, thereby reducing their workability and effectively shortening their shelf life. Surprisingly, the activity of the basic metal compound as a carbon dioxide scavenger is not noticeably impaired. As a result, the chelating agent stabilizes the compositions of the present invention and maintains their workability or even improves the workability, thereby increasing their shelf life.

### Second Additive (Alkoxysilanes)

The compositions according to the invention can optionally comprise a second additive, which is sometimes useful in assisting the first additive in its effect of stabilizing the compositions of the present invention and maintaining their workability, thereby increasing their shelf life.

The second additive is selected from the group consisting of alkoxysilanes.

In one aspect the alkoxysilanes are of the formula

Si(O—X)ₘYₙZ₄₋ₘ₋ₙ
wherein
each X is a C₁- to C₆-alkyl group, preferably a C₁- to C₃-alkyl group, most preferably methyl or ethyl,
each Y is a C₁- to C₂₀-alkyl or a C₅- to C₁₀-aryl group,
each Z is a C₁- to C₆-alkyl group, particularly a saturated C₁- to C₆-alkyl group or an unsaturated C₁- to C₆-alkyl group, such as e.g. vinyl, and which optionally carries a functional group, preferably a functional group selected from the group consisting of glycidyloxy, acryloyloxy, methacryloyloxy, amino and hydroxy, preferably glycidyloxy, acryloyloxy, methacryloyloxy and amino, more preferably glycidyloxy, acryloyloxy and methacryloyloxy,
m is an integer from 1 to 4, preferably m is 3, and
n is an integer from 0 to 3.

Each X can be selected independently from or identically to all other X if occurring at least twice, preferably is selected identically to all other X. Each Y can be selected independently from or identically to all other Y if occurring at least twice, preferably is selected identically to all other Y. Each Z can be selected independently from or identically to all other Z if occurring at least twice, preferably is selected identically to all other Z.

The alkoxysilanes can react as silane coupling agents owing to the presence of at least one alkoxy group (O—X in the above general formula for the alkoxysilanes) as a hydrolysable group bonded to the silicon atom and at least one organic group (Y and/or Z in the above general formula for the alkoxysilanes) bonded to the same silicon atom. Although it has been reported that epoxides are able to react with isocyanates to form oxazolidones, it has been found that the presence of an epoxy group in the organic group (in case of the organic group being represented by Z in the above general formula) of the silane coupling agent is not detrimental to the stability of the isocyanate composition.

In the present invention, the type of alkoxysilane is not particularly limited, as long as the alkoxysilane does not contain active hydrogens. Suitable alkoxysilane are e.g. selected from the group consisting of methyltrimethoxysilane, ethyltrimethoxysilane, propyltrimethoxysilane (particularly n-propyltrimethoxysilane and iso-propyltrimethoxysilane), butyltrimethoxysilane (particularly n-butyltrimethoxysilane, sec-butyltrimethoxysilane and tert-butyltrimethoxysilane), pentyltrimethoxysilane, hexyltrimethoxysilane (particularly n-hexyltrimethoxysilane, 2-hexyltrimethoxysilane and 3-hexyltrimethoxysilane), heptyltrimethoxysilane, octyltrimethoxysilane (particularly n-octyltrimethoxysilane, 2-octyltrimethoxysilane, 3-octyltrimethoxysilane and 4-octyltrimethoxysilane), vinyltrimethoxysilane, vinyltriethoxysilane, vinyltris (β-methoxyethoxy) silane, γ-glycidoxypropyltrimethoxysilane, γ-glycidoxypropyltrimethyldiethoxysilane, γ-glycidoxypropyltriethoxysilane, γ-methacryloxypropylmethyldimethoxysilane, γ-methacryloxypropyltrimethoxysilane, γ-methacryloxypropylmethyldiethoxysilane, γ-methacryloxypropyltriethoxysilane, preferably selected from the group consisting of methyltrimethoxysilane, ethyltrimethoxysilane, propyltrimethoxysilane, butyltrimethoxysilane, octyltrimethoxysilane, vinyltrimethoxysilane and γ-glycidoxypropyltrimethoxysilane, more preferably selected from the group consisting of methyltrimethoxysilane, ethyltrimethoxysilane, propyltrimethoxysilane, butyltrimethoxysilane, octyltrimethoxysilane and γ-glycidoxypropyltrimethoxysilanemore, most preferably methyltrimethoxysilane, octyltrimethoxysilane and γ-glycidoxypropyltrimethoxysilane.

### Polyol

The “polyol” or “polyol compound”, as used interchangeably herein, is a polyhydroxy compound. The “polyol” or “polyhydroxy compound” contains at least two free hydroxy groups. The term “free hydroxy group” denotes an unprotected and reactive hydroxy group, reactive for instance towards an isocyanate group.

The polyol which is reacted with a polyisocyanate to form a prepolymer (in the 1K system or in “part B” of the 2K system) may be selected from the group consisting of polyether polyols, polyester polyols, polyols of fatty acid esters, polyols of modified fatty acid esters, polyols of fatty alcohols, polyols of modified fatty alcohols, polyols of dimeric fatty alcohols, polyols of dimeric modified fatty alcohols, polyols of trimeric fatty alcohols, polyols of trimeric modified fatty alcohols, polycarbonate polyols, polybutadiene polyols and polyacrylate polyols,
preferably selected from the group consisting of polyols of fatty acid esters, polyols of modified fatty acid esters, polyols of fatty alcohols, polyols of modified fatty alcohols, polyols of dimeric fatty alcohols, polyols of dimeric modified fatty alcohols, polycarbonate polyols, polybutadiene polyols and polyacrylate polyols,
more preferably selected from the group consisting of polyols of fatty acid esters, polyols of modified fatty acid esters, polyols of fatty alcohols, polyols of modified fatty alcohols, polycarbonate polyols, polybutadiene polyols and polyacrylate polyols,
yet more preferably selected from the group consisting of polyols of fatty acid esters, polyols of fatty alcohols, polyols of dimeric fatty alcohols, polyols of trimeric fatty alcohols, polycarbonate polyols, polybutadiene polyols and polyacrylate polyols,
yet more preferably selected from the group consisting of polyether polyols, polyester polyols, polyols of fatty acid esters, polyols of fatty alcohols, polyols of dimeric fatty alcohols, polycarbonate polyols, polybutadiene polyols and polyacrylate polyols,
yet more preferably selected from the group consisting of polyether polyols, polyester polyols, polyols of fatty acid esters, polyols of fatty alcohols, polycarbonate polyols, polybutadiene polyols and polyacrylate polyols, most preferably selected from the group consisting of polyether polyols.

The fatty acid esters, fatty alcohols, dimeric fatty alcohols and trimeric fatty alcohols independently from each other may be modified or not.

The polyols of fatty acid esters are preferably selected from the group consisting of polyols of C₁₄ to C₂₂ fatty acid esters, preferably polyols of C₁₆ to C₁₈ fatty acid esters, more preferably polyols of C₁₆ to C₁₈ fatty acid esters, most preferably polyols of C₁₈ fatty acid esters.

The polyols of fatty alcohols are preferably selected from the group consisting of polyols of C₁₄ to C₂₂ fatty alcohols, preferably polyols of C₁₆ to C₁₈ fatty alcohols, more preferably polyols of C₁₆ to C₁₈ fatty alcohols, most preferably polyols of C₁₈ fatty alcohols.

The polyols of dimeric fatty alcohols are preferably selected from the group consisting of polyols of dimeric C₁₄ to C₂₂ fatty alcohols, preferably polyols of dimeric C₁₆ to C₁₈ fatty alcohols, more preferably polyols of dimeric C₁₆ to C₁₈ fatty alcohols, most preferably polyols of dimeric C₁₈ fatty alcohols.

The polyols of trimeric fatty alcohols are preferably selected from the group consisting of polyols of trimeric C₁₄ to C₂₂ fatty alcohols, preferably polyols of trimeric C₁₆ to C₁₈ fatty alcohols, more preferably polyols of trimeric C₁₆ to C₁₈ fatty alcohols, most preferably polyols of trimeric C₁₈ fatty alcohols.

A fatty alcohol denotes an alcohol derived from its corresponding fatty acid ester, i.e. obtainable from its corresponding fatty acid ester e.g. by ester hydrolysis and (chemical) reduction of the free carboxyl group to a (primary) hydroxy group, or e.g. obtainable by (chemical) reduction directly to the corresponding fatty alcohol and the other (ester) alcohol, such as e.g. glycerol (out of a fatty acid glyceride) or methanol (out of a fatty acid methyl ester).

A dimeric fatty alcohol denotes a fatty alcohol which results from the (formal) dimerization of two fatty alcohols. In practice a dimeric fatty alcohol is obtainable e.g. from dimerization of two unsaturated fatty acid ester molecules by reaction between a C—C-double bond in one unsaturated fatty acid ester molecule with a C—C-double bond of another unsaturated fatty acid ester molecule, e.g. by olefin metathesis reaction, followed by ester hydrolysis and reduction of the free carboxyl groups to (primary) hydroxy groups, or followed by reduction of the ester groups directly to (primary) hydroxy groups. The same applies mutatis mutandis to the trimeric fatty alcohols.

A dimeric C₁₄ to C₂₂, dimeric C₁₆ to C₁₈, dimeric C₁₆ to C₁₈ or dimeric C₁₈ fatty alcohol denotes a fatty alcohol having two C₁₄ to C₂₂ fatty alcohol moieties, two C₁₆ to C₁₈ fatty alcohol moieties, two C₁₆ to C₁₈ fatty alcohol moieties or two C₁₈ fatty alcohol moieties, respectively, covalently bonded to each other in a dimer, i.e. in a single molecule; for instance, a dimeric C₁₈ fatty alcohol has two C₁₈ fatty alcohol moieties covalently bonded to each other in a single molecule. The same applies mutatis mutandis to the trimeric fatty alcohols. The polyols of dimeric fatty alcohols are preferably selected from the group consisting of polyols of dimeric C₁₄ to C₂₂ fatty alcohols, preferably polyols of dimeric C₁₆ to C₁₈ fatty alcohols, more preferably polyols of dimeric C₁₆ to C₁₈ fatty alcohols, most preferably polyols of dimeric C₁₈ fatty alcohols.

A modified fatty acid ester is a fatty acid ester in which one or more C—C-double bonds have been subjected to a chemical reaction such as in particular epoxidation, or epoxidation followed by opening of the epoxide by acid or base catalysed hydrolysis, or epoxidation followed by catalysed ring opening in the presence of a diol, e.g. diethylene glycol, resulting in a dihydroxy diether moiety, or hydroformylation. The same applies mutatis mutandis to a modified fatty alcohol, a modified dimeric fatty alcohol and a modified trimeric fatty alcohol.

A fatty acid ester as used herein is usually and in practice a naturally occurring fatty acid ester, such as e.g. a glycerol ester of fatty acids, such as e.g. castor oil. Preferred as fatty acid esters in this invention are unsaturated fatty acid esters having at least one C—C-double bond, particularly for making dimeric fatty alcohols and modified fatty esters.

Preferred polyols of fatty acid esters are selected from castor oil and other glycerol esters of hydroxylated fatty acids. Related materials which can be used include hydrogenated castor oil, glycerol monoricinoleate, glycerol diricinoleate and the blown drying oils such as_blown soya, tung, poppy seed, hemp seed or linseed oils, and partial esters of glycerol with blown drying oil fatty acids.

Preferred polyols of modified fatty acid esters are selected from modified castor oils, e.g. castor oils blended with ketone resin. Modified castor oils are obtainable e.g. by subjecting one or more C—C-double bonds of castor oil to a chemical reaction such as in particular epoxidation, or epoxidation followed by opening of the epoxide by acid or base catalysed hydrolysis, or epoxidation followed by catalysed ring opening in the presence of a diol, e.g. diethylene glycol, resulting in a dihydroxy diether moiety, or hydroformylation, or are obtainable by blending with a ketone resin.

The polyol of the invention typically has from 2 to 6 free hydroxy groups, preferably from 2 to 4 free hydroxy groups, more preferably 2 or 3 free hydroxy groups.

If the polyol is a polyether polyol the polyether polyol is preferably selected from the group consisting of polyethyleneoxide polyol (poly(ethylene oxide) polyol), polypropyleneoxide polyol (poly(propylene oxide) polyol) and polybutyleneoxide polyol (poly(butylene oxide) polyol). Preferably the polyol is a polyether polyol selected from the group consisting of polyethyleneoxide polyol, polypropyleneoxide polyol and polybutyleneoxide polyol, and it has from 2 to 6 free hydroxy groups.

In a further aspect the polyol forming the prepolymer is a polyether polyol selected from the group consisting of polyethyleneoxide polyol, polypropyleneoxide polyol and polybutyleneoxide polyol. The polypropylene polyols may be poly-1,2-propyleneoxide (poly(1,2-propylene oxide)) or poly-1,3-propyleneoxide (poly(1,3-propylene oxide)) polyols. The polybutyleneoxide polyols can be selected from the group consisting of poly-1,2-butyleneoxide polyols (poly(1,2-butylene oxide) polyols), poly-1,3-butyleneoxide polyols (poly(1,3-butylene oxide) polyols) and poly-1,4-butyleneoxide polyols (poly(1,4-butylene oxide) polyols) (also called “poly-THF”), preferably are poly-1,4-butyleneoxide polyols (“poly-THF”).

The polyol can have from 2 to 6 free hydroxy groups, preferably from 2 to 4 free hydroxy groups, more preferably 2 or 3 free hydroxy groups.

The aforementioned polyols may have from 4 to 150, preferably from 4 to 100, more preferably from 4 to 75, most preferably from 9 to 75 repeating units.

In one aspect the polyol is selected from polyethylene glycols having from 4 to 150, preferably from 4 to 100, more preferably from 4 to 75, most preferably from 9 to 75 repeating units.

Chain extenders are often additionally used in the formation of prepolymers. Thus, at least one chain extender is advantageously additionally employed in the formation of a prepolymer from a polyol and a polyisocyanate, more preferably one or two different chain extenders, most preferably one single chain extender. A preferred chain extender is selected from the group consisting of C₂ to C₁₀ alkyl polyols, more preferably selected from the group consisting of 1,2-ethanediol (ethylene glycol), 1,3-propanediol, 1,4-butanediol, 1,3-butanediol, 1,5-pentanediol, 1,6-hexanediol, 2-ethylhexane-1,3-diol, 2,4,4-trimethylhexane-1,6-diol, 2,2,4-trimethylhexane-1,6-diol, 2-ethyl-hexan-1,3-diol, 1,10-decanediol, 2,2-dimethyl-1,3-propanediol, 2-methyl-1,3-propanediol, 1,2-propanediol, 3-methyl-1,5-pentanediol, dialkylene ether glycols such as diethylene glycol and dipropylene glycol.

The chain extender preferably has from 2 to 6, more preferably from 2 to 4, yet more preferably 2 or 3 free hydroxy groups, most preferably two free hydroxy groups.

The second composition (also called “curing agent” or “part A” in the 2K system; the 2K system is also called “two-component system”, as it comprises the composition of the invention and the second composition of the invention) of the invention can include-besides water-polyols as well, such as selected from the group consisting of the following items:
(1) Castor oil and other glycerol esters of hydroxylated fatty acids or fatty alcohol-di- and/or trimers. Related materials which are operative include hydrogenated castor oil, glycerole monoricinolate, glycerine diricinoleate and the blown drying oils such as_blown soya, tung, poppy seed, hemp seed or linseed oils, and partial esters of glycerol with blown drying oil fatty acids.
(2) Polyester polyols prepared by copolymerizing low molecular weight polyols and polycarboxylic acids. These materials are prepared by reacting a mixture containing the polycarboxylic acids and polyols in proportions such that a stoichiometric excess of polyol is present to ensure that the resulting polyester will have a preponderance of terminal hydroxyl groups over terminal carboxyl groups preferably the low molecular weight polyols are predominantly diols, e.g. mono-, di- or tri-ethylene or propylene glycols, 1,4-butanediol and diethanolamine. Advantageously, a minor amount of a triol such as glycerol, hexane triol, trimethylol ethane or trimethylol propane may be included. Suitable acids include adipic, succinic, maleic, isophthalic and terephthalic, acids.
(3) Polyalkylene glycols such as polyethylene glycols, polypropylene glycols or mixed polyethylene-polypropylene glycols, polytetramethylene glycol (poly-THF).
(4) Isocyanate-modified polyols which are obtained by reacting said isocyanates and said polyols in excess of the theoretical amounts.
(5) Polyols derived from dimeric fatty alcohols, as obtained by hydrogenation of dimeric fatty acids. Preferred dimer fatty acids are dimers of C₁₀ to a C₃₀, more preferably C₁₂ to C₂₅, particularly C₁₄ to C₂₂ fatty acids. Suitable dimer fatty acids include the dimerisation products of oleic acid, linoleic acid, linolenic acid, palmitoleic acid and elaidic acid. The dimerisation products of the unsaturated fatty acid mixtures obtained in the hydrolysis of natural fats and oils, e.g., sunflower oil, soybean oil, olive oil, rapeseed oil, cottonseed oil and tall oil may also be used.

Castor oil and other glycerol esters of hydroxyl functionalized fatty acids are preferred components of the curing agent because they facilitate the mixing and homogeneous incorporation of the curing agent into the isocyanate composition and improve the uniform miscibility and fluidity of the mixture.
(6) The polyols as defined above for the prepolymer (used in the 1K system or in “part B” of the 2K system).
(7) A short-chain polyol selected from the group consisting of C₂ to C₁₀ alkyl polyols, more preferably selected from the group consisting of C₂ to C₈ alkyl polyols, yet more preferably selected from the group consisting of C₂ to C₆ alkyl polyols, or selected from the group consisting of 1,2-ethanediol (ethylene glycol), 1,3-propanediol, 1,4-butanediol, 1,3-butanediol, 1,5-pentanediol, 1,6-hexanediol, 2-ethylhexane-1,3-diol, 2,4,4-trimethylhexane-1,6-diol, 2,2,4-trimethylhexane-1,6-diol, 2-ethyl-hexan-1,3-diol, 1,10-decanediol, 2,2-dimethyl-1,3-propanediol, 2-methyl-1,3-propanediol, 1,2-propanediol, 3-methyl-1,5-pentanediol, dialkylene ether glycols such as diethylene glycol and dipropylene glycol, glycerol (1,2,3-propanetriol), sugar alcohols, such as e.g. erythritol, threitol, 2,2-bis(hydroxymethyl) 1,3-propanediol (pentaerythritol), arabitol, xylitol, ribitol, mannitol, sorbitol, galactitol, fucitol, iditol, inositol and volemitol, and trimethylolpropane. The short-chain polyol preferably has from 2 to 6, more preferably from 2 to 4, most preferably 2 or 3 free hydroxy groups.

The second composition preferably comprises water and what is defined at item (6) above, i.e. the polyols as defined herein for the prepolymer. In a further aspect the second composition comprises water, a short-chain polyol as defined above at item (7) and a polyol selected from the group consisting of items (1) to (6) hereinbefore, preferably selected from item (6) hereinbefore.

### Water

Water might be introduced into the system with the application of at least one of the additives of the invention. An additional amount of water may be part of the second composition of the invention.

When using the first composition alone (1K system) it is sufficient to have water present in the form of ambient moisture. Ambient moisture refers to a water content in the ambient atmosphere of at least 25% relative humidity (rel. H.) at 20° C. The composition according to the invention (first composition; part B; 1K system) may contain water in the amount of from 0 wt. % to 6 wt. %, preferably from 0 wt. % to 5 wt. %, more preferably from 0 wt. % to 4 wt. %, yet more preferably from 0 wt. % to 3.6 wt. %, yet more preferably from 0 wt. % to 3.5 wt. %, yet more preferably from 0 wt. % to 3 wt. %, most preferably from 0 wt. % to 2.5 wt. %, based on the total weight of the composition.

Thereby the amount of water present in the two-component coating composition (2K-system; the composition of the invention (part B) as one component and the second composition of the invention (part A) as the other component) may be in the range of from 1 wt. % to 50 wt. %, preferably in the range of from 5 wt. % to 40 wt. %, more preferably in the range of from 10 wt. % to 40 wt. %, yet more preferably of from 15 wt. % to 30 wt. %, most preferably of from 20 wt. % to 30 wt. %, based on the total weight of the two-component composition. Alternatively, the amount of water present in the said two-component coating composition may be in the range of from 0.1 wt. % to 50 wt. %, preferably from 0.5 wt. % to 30 wt. %, more preferably from 0.5 wt. % to 20 wt. %, most preferably from 1 wt. % to 10 wt. %, based on the total weight of the two-component composition.

### Further Ingredients

Depending on the particular coating applications it will be easily understood that these may require further ingredients to be added to the compositions according to the invention.

Thus, the compositions according to the invention may further comprise at least one low volatile organic liquid, preferably at least one low volatile organic liquid having a boiling point of 250° C. or higher, more preferably at least one low volatile organic liquid having a boiling point of 250° C. or higher and selected from the group consisting of plasticizers, flame retardants, monomethacrylates and polymethacrylates.

The plasticizers are preferably selected from the group consisting of phthalates and adipates, more preferably phthalates, such as e.g., dialkyl phthalate.

The flame retardants are preferably selected from the group consisting of phosphoric esters. Suitable flame retardants include, for example, tricresyl phosphate, tris(2-chloroethyl) phosphate, tris(2-chloropropyl) phosphate, tris(1,3-dichloropropyl) phosphate, tris(2,3-dibromopropyl) phosphate and tetrakis(2-chloroethyl)ethylene diphosphate.

The polymethacrylates are selected from the group consisting of dimethacrylates, preferably polyether dimethacrylates, most preferably alkyl dimethacrylates.

The compositions according to the invention can further comprise at least one inorganic compound selected from the group consisting of mica, talc, precipitated silica and fumed silica.

The compositions according to this invention may further comprise one or more catalysts catalysing the isocyanate water reaction, preferably selected from the group consisting of organotin compounds, bismuth carboxylates, zinc carboxylates, trialkylamines and alkylimidazoles, more preferably bisdialkylaminoethyl ethers, most preferably 2,2′-dimorpholinyldiethylether (DMDEE).

In another aspect the catalyst is selected from the group consisting of amines, alkanolamines and metal catalysts, preferably tertiary aliphatic amines. The tertiary aliphatic amine catalyst can be further selected from the group consisting of triethylenediamine, pentamethyldiethylenetriamine, dimethylcyclohexylamine, 2,2′-dimorpholinodiethyl ether, 2-(2-dimethyl-aminoethoxy) ethanol, 2-dimethylaminoethyl 3-dimethyl aminopropyl ether, bis(2-dimethylaminoethyl) ether, N,N-dimethylpiperazine, N-(2-hydroxyethoxyethyl)-2-aza-norboranes, Jeffcat™, N,N,N,N-tetramethylbutane-1,3-diamine, N,N,N,N-tetra-methylpropane-1,3-diamine and N,N,N,N-tetramethylhexane-1,6-diamine, preferably 2,2′-dimorpholinodiethylether. The alkanolamine catalyst can be selected from the group consisting of dimethylethanolamine, triethanolamine and their mixture.

The metal catalyst can be selected from the group consisting of mercury, lead, tin, bismuth, potassium, lithium, titanium, zirconium and zinc catalyst and mixture thereof, and can be further selected from the group consisting of dibutyltin dilaurate (DBTL), stannous octoate, potassium octoate, bismuth neodecanoate and zinc neodecanoate and mixtures thereof.

In a preferred embodiment, the amount of the catalyst is from 0.05 wt. % to 5.0 wt. %, preferably from 0.1 wt. % to 5.0 wt. %, based on the total weight of the composition.

The compositions according to this invention may further comprise at least one ingredient selected from the group consisting of inorganic pigments, organic pigments and dye stuffs, preferably inorganic pigments and organic pigments, most preferably inorganic pigments.

The term “pigment” should be understood as meaning white or coloured, mineral or organic particle which is intended to colour and/or opacify the composition containing it. The pigment may be white or coloured, and mineral and/or organic. Suitable mineral pigments include, but are not restricted to, titanium oxide, titanium dioxide, zirconium oxide, zirconium dioxide, cerium oxide, cerium dioxide, zinc oxide, iron oxide, chromium oxide, ferric blue, manganese violet, ultramarine blue and chromium hydrate, and mixtures thereof. Examples of commercially available pigments are Bayferrox® from Lanxess, Germany and Heucosin® from Heubach.

The compositions of the present invention may also require in some cases including a rheology modifier, as needed. The rheology modifier may be selected from the group consisting of hydrated magnesium silicate, hydrophobic pyrogenic silica, ground barium sulfate (baryte), bentonite, layered double hydroxides, PVC, polyvinylbutyral, substituted and/or oligomeric ureas (e.g. BYK 7410), and amides.

The compositions of the present invention may also require in some cases including a defoamer in their preparation, as needed.

The use of the composition according to the invention for creating a coating is preferably also directed to chemically capturing a sufficient amount of the carbon dioxide released from the reacting polyisocyanate and/or prepolymer by way of forming a bicarbonate and/or carbonate of the metal in the composition, said amount of the carbon dioxide captured being sufficient so as to prevent foaming of the coating.

Likewise, the process according to the invention for creating a coating on a surface, preferably further comprises the step of chemically capturing a sufficient amount of the carbon dioxide released from the reacting polyisocyanate and/or prepolymer by way of forming a bicarbonate and/or carbonate of the metal in the composition, said amount of the carbon dioxide captured being sufficient so as to prevent foaming of the coating.

The composition according to the invention is preferably used for creating a sealing (usually a single-layer coating) or coating in applications selected from flooring and waterproofing. The entire coating may consist of one, two, three or more layers, preferably one or two layers, i.e. on the respective substrate (e.g., concrete or screed) one, two, three or more coating layers may be applied. A typical one-layer coating may be employed as a sealing. A typical two-layer coating, particularly in flooring applications, may consist of a base coat or scratch coat applied to the substrate and a topcoat or body coat subsequently applied on top of the base coat or scratch coat. There may also be a primer applied to the substrate (e.g., concrete or screed) before coating, i.e. before the composition according to the invention is applied.

The thickness of one coating or coating layer according to the invention, particularly as a topcoat or sealing, may be at least 0.05 mm, preferably at least 0.08 mm, more preferably at least 0.09 mm, most preferably at least 0.1 mm. The thickness of one coating or coating layer according to the invention, particularly as a topcoat or sealing, may not exceed 2.0 mm, preferably not exceed 1.5 mm, more preferably not exceed 1.0 mm, yet more preferably not exceed 0.5 mm, most preferably not exceed 0.3 mm. The thickness of one coating layer, particularly as a topcoat or sealing, may thus range from 0.05 mm to 2.0 mm, preferably from 0.08 mm to 1.5 mm, more preferably from 0.09 mm to 1.0 mm, yet more preferably from 0.1 mm to 0.5 mm, most preferably from 0.05 mm to 0.3 mm or from 0.1 mm to 0.3 mm.

The overall thickness of the coating—including all coating layers if not a single layer is applied alone—may be at least 0.3 mm, preferably at least 1 mm, more preferably at least 2 mm. The overall thickness of the coating—including all coating layers if not a single layer is applied alone—may not exceed 20 mm, preferably not exceed 15 mm, more preferably not exceed 10 mm, yet more preferably not exceed 5 mm, yet more preferably not exceed 3 mm, most preferably not exceed 2 mm. The overall thickness of the coating-including all coating layers if not a single layer is applied alone—may thus range from 0.3 mm to 20 mm, preferably from 0.3 mm to 15 mm, more preferably from 0.3 mm to 10 mm or from 1 mm to 10 mm, yet more preferably from 0.3 mm to 5 mm or from 1 mm to 5 mm, yet more preferably from 0.3 mm to 3 mm or from 1 mm to 3 mm, most preferably from 0.3 mm to 2 mm or from 1 mm to 2 mm.

The composition, two-component composition or coating according to the invention is preferably substantially free of any fibre, fibre reinforcement and/or fibrous reinforcement, more preferably free of any fibre, fibre reinforcement and/or fibrous reinforcement. “Substantially free” in this context means that the amount of any fibre, fibre reinforcement and/or fibrous reinforcement is less than 1 wt. %, preferably less than 0.1 wt. %, more preferably less than 0.01 wt. %, most preferably less than 0.001 wt. %, based on the total weight of the composition, two-component composition or coating, respectively.

### DESCRIPTION OF FIGURE

FIG. 1 shows a composition according to the invention after curing in reactivity test b. As a result, no foaming and a nice and smooth surface is visible.

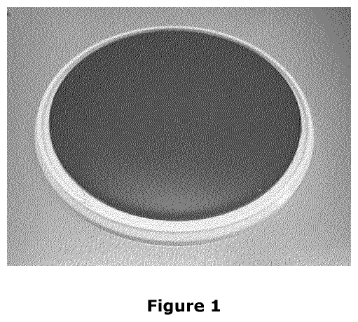

### EXAMPLES

Materials Used and their Sources:
Dispersion medium: Palatinol® N (BASF)—diisononyl phthalate
Calcium oxide: Ground white fine quicklime, burnt or based on natural limestone (sieve analysis: mesh 0.045 mm, residue 0.2%)

### Aliphatic Isocyanates:

Desmodur® N 3600—HDI trimerisate of low viscosity
Vestanat® H12—MDI (Evonik)

### Aromatic Isocyanates:

Lupranat® M20 S (BASF)—4,4′-diphenylmethane diisocyanate (MDI) containing oligomers of high functionality and isomers (average functionality of 2.7)
Lupranat® MI (BASF)—mixture of 2,4′- and 4,4′-diphenylmethane diisocyanate (MDI)

### Isocyanate Prepolymers—Preparation Procedure of an Isocyanate in the Form of a Prepolymer Based on H12MDI for Examples 24 and 25:

220 g Vestanat® H12-MDI and 379.5 g Acclaim® 4200 are heated in an oil-bath under stirring to 40° C. The oil-bath is removed and 0.5 g DOTL are added. After the temperature in the flask does not rise anymore the mixture is heated under stirring to 60-70° C. until the target NCO-value (9.5-10.3%) is reached (about 2 h).

### Polyols:

Acclaim® Polyol 4200 (Covestro)—polypropylenglycol
Arcol® Polyol 1104 (Covestro)—trifunctional polyether polyol

### Rheology Modifiers:

Microtalc IT extra (Elementis)—hydrated magnesium silicate
Aerosil® R 202 (Evonik)—hydrophobic pyrogenic silica
“Barytmehl N” (Sachtleben Minerals)—ground natural barium sulfate (baryte), d50 3 μm
Defoamer: BYK-088 (Byk)

### Additives (Surface Modification):

Cublen® R60 (Zschimmer & Schwarz)—60 wt. % solution of a mixture of [[(Hydroxyethyl)imino]bis(methylen)]bisphosphonic acid and P-[(tetrahydro-2-hydroxy-2-oxido-4H-1,4,2-oxazaphosphorin-4-yl)methyl]phosphonic acid (HEMPA) in water (corresponding to 40 wt. % water);
Melment® F15 (BASF)—Melaminsulfonate condensate, spray-dried version;
Sokalan® PA 25 CL (BASF)—Polyacrylic acid (˜ 4000 g/mol);
TRISIZE 68 (TRIGON Chemie)—mixture of dihydro-3-(octadecenyl) furan-2,5-dione and dihydro-3-(hexadecenyl) furan-2,5-dione (as carboxylic anhydrides); Modified imino-bis(methylphosphonic acid) of the following formula A

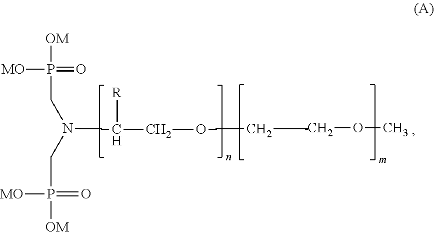

wherein R is H or CH₃, with H/CH₃=3:1 (random), n is 35, m is 6 and M is H and/or Na (part-neutralized solution at ca. pH 4), ca. 55 wt. % solution thereof in water (corresponding to ca. 45 wt. % water);
HDTMPA (Sigma-Aldrich)—diethylenetriamine-pentakis-(methylphosphonic acid), 50 wt. % solution in water (corresponding to 50 wt. % water);
4,5-Dihydroxybenzene-1,3-disulfonic acid disodium salt (Sigma-Aldrich);
Anilin-2,5-disulfonic acid (Alfa-Aesar);
Gluconic acid (Merck);
Lysin (Merck-Sigma-Aldrich);
Glutamic acid (Merck-Sigma-Aldrich);
Adipic acid (Merck-Sigma-Aldrich);
Dynasylan® GLYMO (Evonik)—(3-Glycidyloxypropyl) trimethoxysilane;
Ethylene glycol (Bernd Kraft);
PeCeFlux® 2500 L/45% N.D. (MBCC Group)—45 wt. % solution of a polycarboxylate ether (PCE) in water (corresponding to 55 wt. % water).

### Preparation Procedure for Compositions Containing Isocyanate in Comparative Examples 1 and 2 and Examples 1 to 23

Calcium oxide is dispersed in Palatinol® N (BASF) and no additive or corresponding additive or additive mixture is added and dispersed with a speedmixer (30 s, 3500 rpm). After 1 h in some examples a rheology modifier is added and dispersed (speedmixer, 1 min, 3500 rpm) and left for 15 min. The dispersion is mixed with isocyanate component in a speedmixer (1 min, 3500 rpm).

### Preparation Procedure for Compositions Containing Isocyanate in Examples 24 and 25

Calcium oxide is dispersed in Palatinol® N (BASF) and the respective additive (Example 24: Cublen® R60 (HEMPA); Example 25: TRISIZE 68) is added and dispersed with a speedmixer (30 s, 3500 rpm). 32.7 g of the dispersion obtained are mixed with 67.3 g of the isocyanate prepolymer (prepared as described hereinbefore) in a speedmixer (1 min, 3500 rpm).

### Isocyanate Containing Compositions (Corresponding to Part B for the Storage Stability Tests and Reactivity Tests):

| | Comparative | Comparative | | | |
|---|---|---|---|---|---|
| | Example 1 | Example 2 | Example 1 | Example 2 | Example 3 |
| Additive 1 | ./. | ./. | Cublen ® | Modified imino- | HDTMPA |
| | | | R60 | bis(methylphosphonic | |
| | | | (HEMPA) | acid) of formula A | |
| | | | | and as further | |
| | | | | defined above | |
| Additive 2 | ./. | ./. | ./. | ./. | ./. |
| Additive content | ./. | ./. | 1.50% | 0.35% | 0.70% |
| [g]/CaO | | | | | |
| content [g] | | | | | |
| NCO content | 18.90% | 21.2% | 21.1% | 21.2% | 21.2% |
| CaO [g]/ | 45.0% | 27.8% | 27.8% | 27.8% | 27.8% |
| Isocyanate [g] | | | | | |
| Composition | | | | | |
| Palatinol ® N [g] | 13.15 | 14 | 13.95 | 13.98 | 13.98 |
| CaO [g] | 26.95 | 18.71 | 18.66 | 18.7 | 18.68 |
| Lupranat ® | 59.9 | 67.29 | 67.11 | 67.25 | 67.21 |
| M20 S [g] | | | | | |
| Additive 1 [g] | ./. | ./. | 0.28 | 0.07 | 0.13 |
| Additive 2 [g] | ./. | ./. | ./. | ./. | ./. |

| | Example 4 | Example 5 | Example 6 | Example 7 | Example 8 |
|---|---|---|---|---|---|
| Additive 1 | 4,5-Dihydroxy- | Aniline- | Melment ® | Trisize 68 | Gluconic |
| | benzene-1,3- | 2,5- | F15 | | acid |
| | disulfonic acid | disulfonic | | | |
| | disodium salt | acid | | | |
| Additive 2 | ./. | ./. | ./. | Dynasylan ® | ./. |
| | | | | GLYMO | |
| Additive content | 0.70% | 6% | 4.50% | 5% (Additive 1), | 1.50% |
| [g]/CaO | | | | 2.4% (Additive 2) | |
| content [g] | | | | | |
| NCO content | 21.2% | 21.0% | 21.0% | 20.9% | 21.1% |
| CaO [g]/ | 27.8% | 27.8% | 27.8% | 27.8% | 27.8% |
| Isocyanate [g] | | | | | |
| Composition | | | | | |
| Palatinol ® N [g] | 13.98 | 13.84 | 13.89 | 13.82 | 13.95 |
| CaO [g] | 18.68 | 18.5 | 18.55 | 18.45 | 18.66 |
| Lupranat ® | 67.21 | 66.55 | 66.73 | 66.37 | 67.11 |
| M20 S [g] | | | | | |
| Additive 1 [g] | 0.13 | 1.11 | 0.83 | 0.92 | 0.28 |
| Additive 2 [g] | ./. | ./. | ./. | 0.44 | ./. |

| | Example 9 | Example 10 | Example 11 | Example 12 | Example 13 |
|---|---|---|---|---|---|
| Additive 1 | Lysine | Glutamic | Serine | Adipic acid | Sokalan ® PA |
| | | acid | | | 25CL |
| Additive 2 | ./. | ./. | ./. | ./. | ./. |
| Additive content | 0.35% | 0.70% | 1.50% | 0.70% | 1.50% |
| [g]/CaO | | | | | |
| content [g] | | | | | |
| NCO content | 21.2% | 21.2% | 21.1% | 21.2% | 21.1% |
| CaO [g]/ | 27.8% | 27.8% | 27.8% | 27.8% | 27.8% |
| Isocyanate [g] | | | | | |
| Composition | | | | | |
| Palatinol ® N [g] | 13.98 | 13.98 | 13.95 | 13.98 | 13.95 |
| CaO [g] | 18.7 | 18.68 | 18.66 | 18.68 | 18.66 |
| Lupranat ® | 67.25 | 67.21 | 67.11 | 67.21 | 67.11 |
| M20 S [g] | | | | | |
| Additive 1 [g] | 0.07 | 0.13 | 0.28 | 0.13 | 0.28 |
| Additive 2 [g] | ./. | ./. | ./. | ./. | ./. |

| | Example 14 | Example 15 | Example 16 | Example 17 | Example 18 |
|---|---|---|---|---|---|
| Additive 1 | Trisize 68 | Cublen ® | Melment ® | Cublen ® | Melment ® |
| | | R60 | F15 | R60 | F15 |
| | | (HEMPA) | | (HEMPA) | |
| Additive 2 | Dynasylan ® | ./. | ./. | ./. | ./. |
| | GLYMO | | | | |
| Additive content | 5% (Additive 1), | 1.50% | 4.50% | 0.70% | 4.50% |
| [g]/CaO | 2.4% (Additive 2) | | | | |
| content [g] | | | | | |
| NCO content | 18.50% | 22.3% | 22.3% | 15.5% | 13.6% |
| CaO [g]/ | 45.0% | 27.8% | 27.8% | 27.8% | 45.0% |
| Isocyanate [g] | | | | | |
| Composition | | | | | |
| Palatinol ® N [g] | 12.89 | 13.82 | 13.74 | 13.98 | 12.99 |
| CaO [g] | 26.43 | 18.47 | 18.37 | 18.68 | 26.63 |
| Lupranat ® | 58.73 | ./. | ./. | ./. | ./. |
| M20 S [g] | | | | | |
| Lupranat ® MI [g] | ./. | 66.44 | 66.08 | ./. | ./. |
| Desmodur ® N3600 | ./. | ./. | ./. | 67.21 | 59.18 |
| [g] | | | | | |
| Aerosil ® R202 [g] | ./. | 0.99 | 0.98 | ./. | ./. |
| Additive 1 [g] | 1.32 | 0.28 | 0.83 | 0.13 | 1.20 |
| Additive 2 [g] | 0.63 | ./. | ./. | ./. | ./. |
| | Example 19 | Example 20 | Example 21 | Example 22 | Example 23 |
| Additive 1 | Trisize 68 | Cublen ® | Cublen ® | Cublen ® | Cublen ® |
| | | R60 | R60 | R60 | R60 |
| | | (HEMPA) | (HEMPA) | (HEMPA) | (HEMPA) |
| Additive 2 | Dynasylan ® | ./. | ./. | ./. | ./. |
| | GLYMO | | | | |
| Additive content | 5% (Additive 1), | 1.50% | 1.50% | 1.50% | 1.50% |
| [g]/CaO | 2.4% (Additive 2) | | | | |
| content [g] | | | | | |
| NCO content | 13.5% | 25% | 15% | 25.6% | 25.6% |
| CaO [g]/ | 45.0% | 19.0% | 41.0% | 10% | 10% |
| Isocyanate [g] | | | | | |
| Composition | | | | | |
| Palatinol ® N [g] | 12.89 | 5.76 | 32.05 | 15.89 | 15.89 |
| CaO [g] | 26.43 | 14.85 | 19.39 | 7.64 | 7.64 |
| Lupranat ® | ./. | 78.18 | 47.28 | ./. | 76.36 |
| M20 S [g] | | | | | |
| Lupranat ® MI [g] | ./. | ./. | ./. | ./. | ./. |
| Desmodur ® N3600 | 58.73 | ./. | ./. | 76.36 | ./. |
| [g] | | | | | |
| H12MDI | ./. | ./. | ./. | ./. | ./. |
| Prepolymer [g] | | | | | |
| Microtalc IT | ./. | 0.99 | 0.99 | ./. | ./. |
| extra [g] | | | | | |
| Additive 1 [g] | 1.32 | 0.22 | 0.29 | 0.11 | 0.11 |
| Additive 2 [g] | 0.63 | ./. | ./. | ./. | ./. |

| | Example 24 | Example 25 |
|---|---|---|
| Additive 1 | Cublen ® R60 (HEMPA) | Trisize 68 |
| Additive 2 | ./. | Dynasylan ® GLYMO |
| Additive content [g]/ | 1.5% | 5% (Additive 1), |
| CaO content [g] | | 2.4% (Additive 2) |
| NCO content | 6.6% | 6.6% |
| CaO [g]/Isocyanate | 27.6% | 26.1% |
| prepolymer [g] | | |
| Composition | | |
| Palatinol ® N [g] | 13.83 | 13.16 |
| CaO [g] | 18.59 | 17.59 |
| Lupranat ® M20 S [g] | ./. | ./. |
| Lupranat ® MI [g] | ./. | ./. |
| Desmodur ® N3600 [g] | ./. | ./. |
| H12MDI Prepolymer [g] | 67.30 | 67.30 |
| Microtalc IT extra [g] | ./. | ./. |
| Additive 1 [g] | 0.28 | 1.32 |
| Additive 2 [g] | ./. | 0.63 |

### Storage Stability Tests:

Part B (iscocyanate containing composition) is stored at 40° C. The storage stability is checked after 1 d, 14 d and 28 d. Part B is called storage stable if a significant increase in viscosity, tested by manually stirring with a spatula, is not observed and the sediment is easily re-dispersible. The sample is not stable anymore if a sediment of CaO is not re-dispersible or the viscosity is significantly increased.

Viscosity is measured using a Rheometer (from Anton Paar) at 50 1/s after 1 min.

| | Viscosity [mPa · s] | | | | |
|---|---|---|---|---|---|
| Storage | Comparative | Comparative | | | |
| time | Example 1 | Example 2 | Example 1 | Example 2 | Example 3 |
| 1 d | 360 | 312 | 322 | 321 | 329 |
| 14 d | n.m. | 295 | 343 | 345 | 334 |
| 28 d | n.m. | n.m. | 377 | 273 | 339 |
| | sediment | sediment | easily re- | easily re- | well re- |
| | not re- | not re- | dispersible | dispersible | dispersible |
| | dispersible | dispersible | | | sediment |

| Storage | Viscosity [mPa · s] | | | | |
|---|---|---|---|---|---|
| time | Example 4 | Example 5 | Example 6 | Example 7 | Example 8 |
| 1 d | 311 | 310 | 436 | 312 | 330 |
| 14 d | 348 | 255 | 531 | 309 | 297 |
| 28 d | 385 | 309 | 595 | 562 | 329 |
| | well re- | re- | re- | hardly re- | re- |
| | dispersible | dispersible | dispersible | dispersible | dispersible |
| | sediment | sediment | sediment | sediment | sediment |

| Storage | Viscosity [mPa · s] | | | | |
|---|---|---|---|---|---|
| time | Example 9 | Example 10 | Example 11 | Example 12 | Example 13 |
| 1 d | 255 | 288 | 327 | 303 | 339 |
| 14 d | 271 | 247 | 225 | 304 | 379 |
| 28 d | 328 | 309 | 309 | 358 | 368 |
| | hardly re- | hardly re- | hardly re- | re- | well re- |
| | dispersible | dispersible | dispersible | dispersible | dispersible |
| | sediment | sediment | sediment | sediment | sediment |
| Storage | Viscosity [mPa · s] | | | | |
| time | Example 14 | Example 15 | Example 16 | Example 17 | Example 18 |
| 1 d | 375 | 448 | 483 | 1168 | 1354 |
| 14 d | 593 | 372 | 426 | 1088 | 1487 |
| 28 d | 828 | 407 | 354 | 1375 | 1546 |
| | well re- | easily re- | easily re- | easily re- | well re- |
| | dispersible | dispersible | dispersible | dispersible | dispersible |
| | sediment | | | | sediment |
| Storage | Viscosity [mPa · s] | | | | |
| time | Example 19 | Example 20 | Example 21 | Example 22 | Example 23 |
| 1 d | 1305 | 248 | 306 | 974 | 246 |
| 14 d | 1392 | 262 | 278 | 944 | 252 |
| 28 d | 1331 | 317 | 357 | 945 | 264 |
| | well re- | well re- | well re- | well re- | easily re- |
| | dispersible | dispersible | dispersible | dispersible | dispersible |
| | sediment | sediment | sediment | sediment | |

n.m.: not measurable

Storage at 50° C. (isocyanate prepolymer based on H12 MDI):

| | |
|---|---|
| Storage | Viscosity [mPa · s] |

| time | Example 24 | Example 25 |
|---|---|---|
| 1 d | 2940 | 2490 |
| 7 d | 3000 | 2670 |
| 14 d | 3010 | 2710 |
| 28 d | 3800 | 2900 |

### Reactivity Tests:

The reactivity tests serve to assess whether CaO is still sufficiently reactive towards water to form Ca(OH)₂ in order to then scavenge CO₂ formed by the reaction of isocyanate with water. To this end the mixtures of Part A with the various forms of Part B are poured onto plates and checked for any foaming.

Preparation of Part A being Reactive Towards the Isocyanate Containing Composition (Part B):

20.7 g of water are mixed with 2.6 g of PeCeFlux® 2500 L/45% N. D., 22.6 g of ethylene glycol and 4.8 g of ground Baryte N. 45.9 g of Arcol® Polyol 1104 and 2.4 g of BYK-088 are added and mixed thoroughly.

### Preparation of Part B (Isocyanate Containing Composition):

Calcium oxide (29.5 g) is dispersed in Palatinol® N (14.4 g) and no additive or corresponding additives (Melment® F15 (1.33 g), or Cublen® R60 (HEMPA) (0.21 g) or (0.44 g) or mixture of Trisize 68 (1.48 g) and Dynasylan® GLYMO (0.35 g) is added. After 1 h the dispersion is mixed with Lupranat® M20S (65.4 g).

Mixing of Part A (PTA) with Part B (PTB):

Part A is added to Part B in the ratios as listed in the following table, depending on the kind of modification of CaO, and mixed thoroughly for 1 min at 3500 rpm in a speedmixer. Then 65 g of the mixture is poured onto a plate (20 cm in diameter (Jokey)). The surface is visually examined after curing as to whether there is a smooth surface or a rough and uneven surface with waves and/or bubble holes indicating foaming. If there is foaming, the amount of CaO in percentage (weight ratio CaO [g]/isocyanate [g]) is increased in 5% steps until no foaming is observed; this final %-amount of CaO at which no foaming is observed anymore is stated in the following table, last column.

| | | | Mixing ratios | | |
|---|---|---|---|---|---|
| | Weight | | PTA:PTB (water | | Weight |
| | ratio of | | and polyol/ | Storage | ratio of |
| | CaO [g]/ | CaO | isocyanate | stability | CaO [g]/ |
| Reactivity | isocyanate | modified | ratio is kept | of Part B | isocyanate [g] |
| Test | [g] | with | constant): | (PTB)* | (no foaming) |
| a | 45% | unmodified | 100:394 | −− | 45% |
| b | 45% | 0.7 weight-% | 100:395 | + | 45% |
| | | HEMPA | | | |
| c | 20% | 1.5 weight-% | 100:336 | ++ | 20% |
| | | HEMPA | | | |
| d | 45% | 4.5 weight-% | 100:399 | ++ | 40% |
| | | Melment ® F15 | | | |

*Meanings:
++ storage stability of more than 12 weeks at 40° C.
+ storage stability of 4 to 10 weeks at 40° C.
−− no storage stability (less than 1 week)

1. Composition comprising
(a) at least one polyisocyanate,
(b) particles of at least one basic metal compound independently selected from the group consisting of basic metal oxide compounds and basic metal hydroxide compounds, and
(c) at least one first additive which is a chelating agent comprising at least two functional groups capable of binding to a cation of the metal.

2. Composition according to claim 1, wherein the at least one polyisocyanate
(a.1) has from 2 to 6 free isocyanate groups, and/or
(a.2) is independently selected from the group consisting of aliphatic and aromatic polyisocyanates.

3. Composition according to claim 1, wherein the at least one polyisocyanate is a prepolymer formed of at least one polyol and at least one polyisocyanate.

4. Composition according to claim 3, wherein the at least one polyol
(i) is independently selected from the group consisting of polyether polyols, polyester polyols, polyols of fatty acid esters, polyols of modified fatty acid esters, polyols of fatty alcohols, polyols of modified fatty alcohols, polyols of dimeric fatty alcohols, polyols of dimeric modified fatty alcohols, polyols of trimeric fatty alcohols, polyols of trimeric modified fatty alcohols, polycarbonate polyols, polybutadiene polyols and polyacrylate polyols, and/or
(ii) has from 2 to 6 free hydroxy groups, and
(iii) optionally comprises at least one further polyol which is a chain extender and has from 2 to 6 free hydroxy groups.

5. Composition according to claim 4, wherein the at least one polyol
(i) is independently selected from the group consisting of polyether polyols, polyester polyols, polycarbonate polyols, polybutadiene polyols and polyacrylate polyols, and/or
(ii) has from 2 to 6 free hydroxy groups, and/or
(iii) has from 4 to 150 repeating units.

6. Composition according to claim 4, wherein the at least one polyol
(i) is a polyether polyol independently selected from the group consisting of polyethyleneoxide polyol, polypropyleneoxide polyol and polybutyleneoxide polyol, and/or
(ii) has from 2 to 6 free hydroxy groups, and/or
(iii) has from 4 to 150 repeating units.

7. Composition according to claim 1, wherein the metal of the at least one basic metal compound is independently selected from the group consisting of alkaline metals, alkaline earth metals, metals of the 2^{nd} transition metal group and metals of the 3^{rd} transition metal group.

8. Composition according to claim 1, wherein the metal of the at least one basic metal compound is independently selected from the group consisting of alkaline earth metals.

9. Composition according to claim 1, in which the at least one basic metal compound comprises cement.

10. Composition according to claim 1, wherein the at least one chelating agent
(i) comprises at least one functional group being independently selected from the group consisting of acid groups and their corresponding acid anions, salts, amides, anhydrides and esters, and optionally
(ii) comprises at least one sterically hindering group.

11. Composition according to claim 10, wherein
(i) the at least one functional group is independently selected from the group consisting of carboxylic acid, sulfonic acid, phosphonic acid and phosphoric acid, their corresponding acid anions and acid salts, carboxamide, carboxylic esters and carboxylic anhydrides, and/or
(ii) the at least one sterically hindering group is independently selected from the group consisting of a C₄- to C₁₀₀-hydrocarbon tail and/or a polyether.

12. Composition according to claim 1, wherein the chain between the functional groups binding to the metal cation is a C₂- to C₁₀-hydrocarbon backbone, and wherein at least one methylene group of the C₂- to C₁₀-hydrocarbon backbone optionally
(i) is substituted by a heteroatom independently selected from the group consisting of N, P, O and S, or
(ii) carries a functional group independently selected from the group consisting of acid groups and their corresponding acid anions, salts, amides, anhydrides and esters, and amino and hydroxy.

13. Composition according to claim 1 further comprising
(d) at least one second additive independently selected from the group consisting of alkoxysilanes.

14. Composition according to claim 13, wherein the alkoxysilanes are of formula Si(O—X)ₘYₙZ₄₋ₘ₊ₙ, wherein
X is a C₁- to C₆-alkyl group,
Y is a C₁- to C₂₀-alkyl or a C₅- to C₁₀-aryl group,
Z is a C₁- to C₆-alkyl group, which optionally carries a functional group,
m is an integer from 1 to 4, and
n is an integer from 0 to 3.

15. Composition according to claim 1, further comprising at least one low volatile organic liquid.

16. Composition according to claim 15, wherein
(i) the plasticizers are selected from the group consisting of phthalates and adipates, and/or
(ii) the flame retardants are selected from the group consisting of phosphoric esters, and/or
(iii) the polymethacrylates are selected from the group consisting of dimethacrylates.

17. Composition according to claim 1, further comprising at least one inorganic compound independently selected from the group consisting of mica, talc, precipitated silica and fumed silica.

18. Composition according to claim 1, further comprising at least one catalyst catalysing the isocyanate water reaction.

19. Composition according to claim 1, further comprising at least one ingredient independently selected from the group consisting of inorganic pigments, organic pigments and dye stuffs.

20. Kit comprising the composition as defined in claim 1 and a second composition which is a liquid comprising water for reaction with the at least one polyisocyanate and/or prepolymer and optionally for reaction with the at least one basic metal compound.

21. Kit according to claim 20, wherein the second composition further comprises at least one polyol.

22. A method comprising creating a coating by reaction with ambient moisture with the composition as defined in claim 1.

23. A method comprising:
mixing the composition as defined in claim 1 with a second composition which is a liquid comprising water for reaction with the at least one polyisocyanate and/or prepolymer and optionally for reaction with the at least one basic metal compound; and
creating a coating.

24. A method comprising chemically capturing by way of forming a bicarbonate and/or carbonate of the at least one metal in the composition of the kit of claim 20 a sufficient amount of the carbon dioxide released from the reacting at least one polyisocyanate and/or prepolymer the amount of the carbon dioxide captured being sufficient so as to prevent foaming of the coating.

25. Process for creating a coating on a surface, comprising the steps of
(i) providing a composition as defined in claim 1,
(ii) allowing the presence of ambient moisture,
(iii) applying the composition onto the surface, and
(iv) allowing the composition as applied in step (iii) to cure while it is in contact with the ambient moisture.

26. Process for creating a coating on a surface, comprising the steps of
(i) providing a first composition as defined in claim 1,
(ii) providing a second composition which is a liquid comprising water for reaction with the at least one polyisocyanate and/or prepolymer and optionally for reaction with the at least one basic metal compound,
(iii) mixing the first and second composition,
(iv) applying the mixture obtained in step (iii) onto the surface, and
(v) allowing the mixture as applied in step (iv) to cure.

27. The process according to claim 25, further comprising the step of chemically capturing a sufficient amount of the carbon dioxide released from the reacting at least one polyisocyanate and/or prepolymer by way of forming a bicarbonate and/or carbonate of the at least one metal in the composition, the amount of the carbon dioxide captured being sufficient so as to prevent foaming of the coating.
